(19) United States
(12) Patent Application Publication
(10) Pub. No.: US 2010/0137091 A1
(43) Pub. Date: Jun. 3, 2010

(54) POWER TRAIN OF HYBRID VEHICLE

(75) Inventors: Jongsool Park, Hwaseong (KR); Changwook Lee, Seongnam (KR)

Correspondence Address: EDWARDS ANGELL PALMER & DODGE LLP, P.O. BOX 55874, BOSTON, MA, 02205, US

(73) Assignee: HYUNDAI MOTOR COMPANY, Seoul (KR)

(21) Appl. No.: 12/629,143

(22) Filed: Dec. 2, 2009

(30) Foreign Application Priority Data
Dec. 3, 2008 (KR) 10-2008-121819

(51) Int. Cl. F16H 3/72

(52) U.S. Cl. 475/5; 903/911; 903/912

(57) ABSTRACT

The present invention provide a power train of a hybrid vehicle that can be mounted in plug-in hybrid vehicles as well as environment-friendly vehicles, while reducing the cost and weight with less parts and a simple structure, ensuring good mounting characteristics in a vehicle, and improving fuel efficiency and power performance.

### CROSS-REFERENCE TO RELATED APPLICATIONS

The present application is based on, and claims priority from, Korean Application Serial Number 10-2008-0121819, filed on Dec. 3, 2008, the disclosure of which is hereby incorporated by reference herein in its entirety.

### TECHNICAL FIELD

The present disclosure relates to a power train of a hybrid vehicle, in more detail a power train arrangement of a hybrid vehicle that uses an engine, which is an internal combustion engine, and a motor generator driven by electricity as a power source providing driving force to a driving wheel.

### BACKGROUND ART

Hybrid vehicles using an engine and a motor generator improve fuel efficiency of the vehicles by achieving functions of idle stop and regenerative braking, on the basis of a technology of driving the vehicles at low velocity by using power from the motor generator having relatively excellent low-velocity torque characteristics and driving the vehicles at high velocity by using power from the engine having relatively excellent high-velocity characteristics.

Further, hybrid vehicles do not produce exhaust gas from the engine when being driven only by a motor generator, which is recognized as an environment-friendly vehicle technology having advantages of improving fuel efficiency and reducing exhaust gas.

Researches for reducing manufacturing costs, providing simpler structures, providing lighter and less parts, ensuring good mounting characteristics, and improving fuel efficiency and power performance have been continuously conducted.

The information disclosed in this Background Art section is only for enhancement of understanding of the general background of the invention and should not be taken as an acknowledgement or any form of suggestion that this information forms the prior art already known to a person skilled in the art.

### SUMMARY OF THE DISCLOSURE

Embodiments of the present invention provide a power train of a hybrid vehicle which can be mounted in common hybrid vehicles, which are environmental-friendly vehicles, and plug-in hybrid vehicles, while reducing the cost and weight with less parts and a simple structure, and improving fuel efficiency and power performance.

In one aspect, the present invention provides a power train of a hybrid vehicle that comprises a first planetary gear set, a second planetary gear set, a first clutch, and a second clutch. The first planetary gear set is connected with an output element and a first motor generator. The second planetary gear set is aligned coaxially with the first planetary gear set and connected with the output element, an input element, and a second motor generator. The first clutch is configured to selectively fix a mode shift gear element of the first planetary gear set. The second clutch is configured to selectively connect the mode shift gear element of the first planetary gear set with a gear element of the second planetary gear set that is not connected with the second motor generator and the output element.

In another aspect, the present invention provides a power train of a hybrid vehicle that comprises a first planetary gear set, a second planetary gear set, a first clutch, a second clutch, a third clutch, and a fourth clutch. The first planetary gear set is connected with an output element and a first motor generator. The second planetary gear set is connected with an input element and a second motor generator. The first clutch is connected with a gear element of the first planetary gear set that is not connected with the output element. The second clutch is connected with a gear element of the second planetary gear set that is not connected with the second motor generator and the output element. The third clutch is connected with a gear element of the second planetary gear set that is not connected with the output element. The fourth clutch is connected with the first planetary gear set and the second planetary gear set.

The above and other features and advantages of the present invention will be apparent from or are set forth in more detail in the accompanying drawings, which are incorporated in and form a part of this specification, and the following Detailed Description, which together serve to explain by way of example the principles of the present invention.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

### BRIEF DESCRIPTION OF THE DRAWINGS

For better understanding of the nature and objects of the present invention, reference should be made to the following detailed description with the accompanying drawings, in which:

FIG. 1 is a diagram illustrating an embodiment of a power train of a hybrid vehicle according to the present invention;

FIG. 2 is a diagram illustrating another embodiment of a power train of a hybrid vehicle according to the present invention;

FIG. 3 is a diagram illustrating still another embodiment of a power train of a hybrid vehicle according to the present invention; and

FIG. 4 is an operation table of clutches that are operated for each driving mode in the power trains of FIGS. 1-3.

### DETAILED DESCRIPTION OF EMBODIMENTS

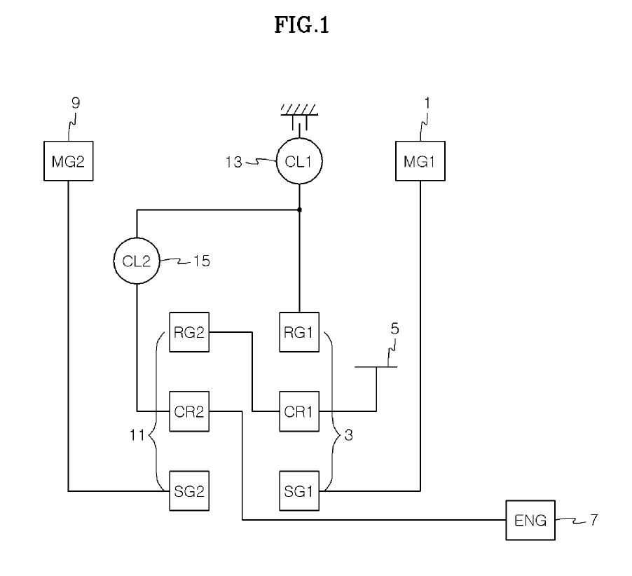

Referring to FIG. 1, a power train of a hybrid vehicle according to an embodiment of the present invention includes a first planetary gear set 3, a second planetary gear set 11, a first clutch 13, and a second clutch 13.

The first planetary gear set 3 is connected with an output element 5 and a first motor generator 1. The second planetary gear set 11 is disposed coaxially with the first planetary gear set 3 and connected with the output element 5, an input element 7, and a second motor generator 9. The first clutch 13 is provided to selectively fix a mode shift gear element of the first planetary gear set 3. The second clutch 15 is provided to selectively connect the mode shift gear element of first planetary gear set 3 with an element of the second planetary gear set 11 that is connected neither with the second motor generator 9 nor with the output element 5.

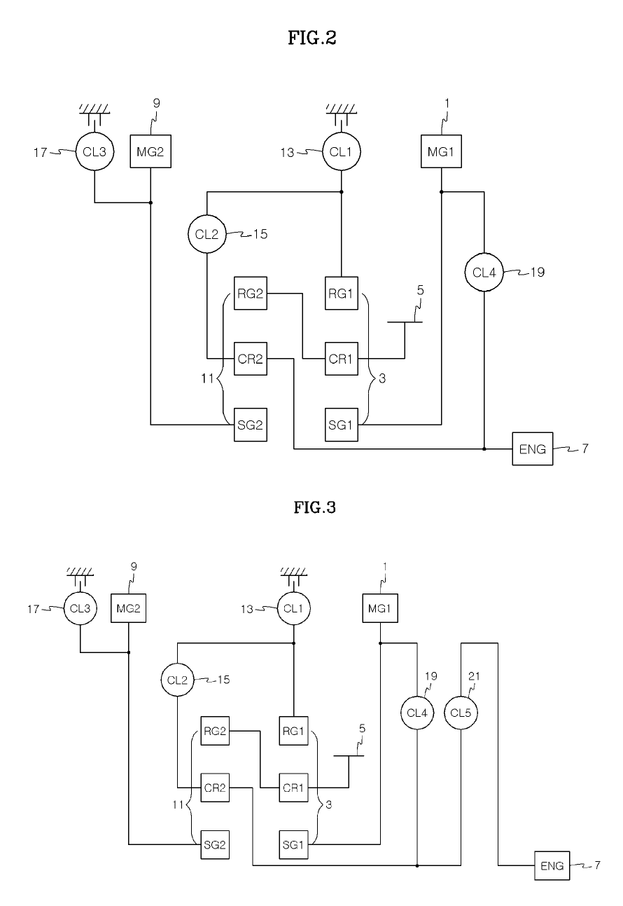

According to another embodiment of the present invention, as shown in FIG. 2, in addition to the configuration of the embodiment shown in FIG. 1, the power train may further include a third clutch 17 and a fourth clutch 19.

The third clutch 17 is disposed to selectively fix an element of the second planetary gear set 11 which is connected with the second motor generator 9. The fourth clutch 19 is provided to selectively connect the element of the second planetary gear set 11 that is connected neither with the second motor generator 9 nor with the output element 5 with an element of the first planetary gear set 3 that is connected with the first motor generator 1.

According to still another embodiment of the present invention, as shown in FIG. 3, Further, in addition to configuration of the embodiment shown in FIG. 2, the power train may further include a fifth clutch 2 that is provided to selectively connect the input element 7 with an element of the second planetary gear set 11.

In all of the embodiments shown in FIGS. 1 to 3, the output element 5 is connected with a carrier CR1 of the first planetary gear set 3 and a ring gear RG2 of the second planetary gear set 11 and the mode shift gear element of the first planetary gear set 3 is a ring gear RG1.

The first motor generator 1 is connected to a sun gear SG1 of the first planetary gear set 3, the output element 5 is connected to the carrier CR1 of the first planetary gear set 3, and the first clutch 13 and second clutch 15 are connected to the ring gear RG1 of the first planetary gear set 3. Suitably, the output element 5 may be connected to the ring gear RG1 of the first planetary gear set 3 and the first clutch 13 and the second clutch 15 may be connected to the carrier CR1 of the first planetary gear set 3, while the first motor generator 1 is connected to the sun gear SG1.

The second motor generator 9 is connected to a sun gear SG2 of the second planetary gear set 11, the output element 5 is connected to the ring gear RG2 of the second planetary gear set 11, and the input element 7 and the second clutch 15 are connected to a carrier CR2 of the second planetary gear set 11. Suitably, the configuration may be implemented in an inverse way, e.g., that the output element 5 may be connected to the carrier CR2 of the second planetary gear set 11 and the input element 7 and the second clutch 15 may be connected to the ring gear RG2 of the second planetary gear set 11 while the second motor generator 9 is connected to the sun gear SG2 of the second planetary gear set 11.

The input element 7 may be an engine and the output element 5 may be a differential connected to driving wheels of the vehicle.

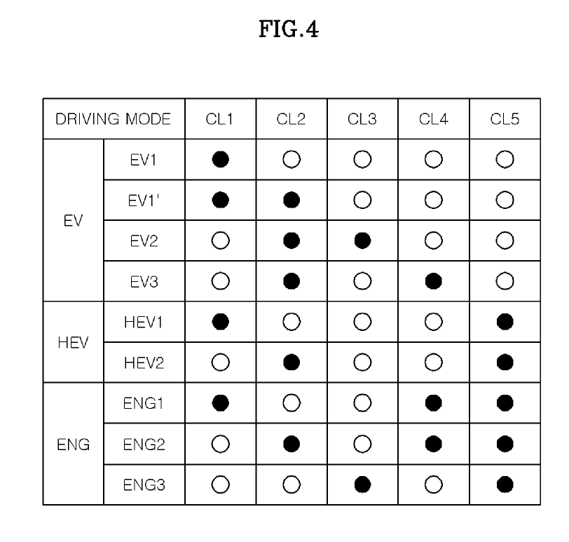

The operation of the power trains according to the present invention is described with the embodiment shown in FIG. 3 and the operation table shown in FIG. 4. The power train according to the embodiment can be operated in various modes: EV1, EV1′, EV2, EV3, HEV1, HEV2, ENG1, ENG2, and ENG3.

The EV1 mode is implemented by fixing the ring gear RG1 by engaging the first clutch 13 and generating torque from the first motor generator 1 connected with the first sun gear SG1. In this mode, an under-drive shift stage is achieved in which the driving force outputted from the first motor generator 1 is reduced in accordance with the shift ratio of the first planetary gear set 3 and outputted through the output element 5 connected to the first carrier CR1.

The EV1′ mode is a mode for maximizing driving force of a vehicle using the first motor generator 1 and the second motor generator 9 as motors in case of rapid acceleration in an EV mode traveling. That is, in this mode, the ring gear RG1 is connected with the carrier CR2 by additionally engaging the second clutch 15 such that the engine is fixed with the ring gear RG1 and the carrier CR2, and the first motor generator 1 and the second motor generator 9 both provide power. When two motor generators generate power, torque exerted in the output element 5 is [gear ratio of the first planetary gear set+1]*[torque of the first motor generator]+[gear ratio of the second planetary gear set 11]*[torque of the second motor generator].

The EV2 mode is a mode for connecting the ring gear RG1 with the carrier CR2 such that the first and second planetary gear sets are integrally operated by engaging the second clutch 15, and for driving only the first motor generator 1 as a motor while fixing the sun gear SG2 by engaging the third clutch 17. In this mode, the rotational velocity of the first motor generator 1 connected to the sun gear SG1 is higher than the carrier CR1 and the ring gear RG2, which are connected with the output shaft, but it is lower than that of the EV1 mode.

The EV3 mode is a driving mode at a transmission ratio of 1.0 which is achieved by rotating all of the gear elements of the first planetary gear set 3 and the second planetary gear set 11 at the same velocity by engaging the second clutch 15 and the fourth clutch 19. In this mode, the torque of the first motor generator 1 is entirely transmitted to the output shaft of the transmission. As a result, the transmission ratio provided by the power train in the EV modes includes two under-drive transmission ratios and one transmission ratio of 1.0.

In the EV modes, since the fifth clutch 21 is disengaged and the gear elements of the second planetary gear set 11 are disconnected with the engine, the operation of the second planetary gear set 11 and the first planetary gear set 3 is free from the velocity of the engine. By contrast, in HEV modes, since the fifth clutch 21 is engaged, power of the engine is transmitted to the driving wheels through second planetary gear set 11.

The HEV1 mode is an input split mode, which is implemented by engaging the fifth clutch 21 in the EV1 mode. That is, the first motor generator 1 connected with the sun gear SG1 generates output torque together with the engine while operating as a motor and the second motor generator 9 connected with the sun gear SG2 implements electronic continuously variable transmission by changing the velocity of the engine connected with the carrier CR2.

The HEV2 mode integrally operates the two planetary gear sets together with the carrier CR1 and the ring gear RG2, which are always connected through the output shaft, by engaging the second clutch 15 such that the ring gear RG1 is connected with the carrier CR2 in the HEV 1 mode. In this operation, not only the two motor generators are electrically connected, but they operate in a compound split mode that should satisfy the velocity-torque relation of the planetary gear sets.

The ENG1 mode achieves an under-drive shift stage by engaging the first clutch 13 in which the sun gear SG1 connected with the first motor generator 1 rotates at high velocity with respect to the carrier CR1 connected with the output shaft, and then engaging fourth clutch 19 in which the carrier CR2 connected with the engine is connected with the sun gear SG1, thereby allowing the engine to achieve an under-drive shift stage with respect to the output shaft. In this operation, the vehicle can be driven by the engine torque through the second planetary gear set, even though both motor generators do not generate torque.

The ENG2 mode is a driving mode at a transmission ratio of 1.0 in which all of the gear elements of the two planetary gear sets rotate at the same velocity by engaging the second clutch 15 and the fourth clutch 19. Accordingly, only gear elements of the second planetary gear set 11 transmit torque and the engine torque is entirely transmitted to the output shaft of the transmission.

The ENG3 mode is a mode that achieves an over-drive shift ratio by engaging the third clutch 17 such that sun gear SG2 is fixed, in which the carrier CR2 connected with the engine rotates at a low velocity with respect to the ring gear RG2 connected to the output shaft. In this operation, since the first motor generator 1 does not transmit torque, all of the gear elements of the first planetary gear set 3 do not transmit torque and a shift stage is achieved only by the second planetary gear set 11.

As a result, the transmission ratio provided by the power train in the ENG modes includes one under-drive transmission ratio, one transmission ratio of 1.0, and one over-drive transmission ratio.

The above-described power train provides two HEV modes of the input split and the compound split modes, and provides an engine driving mode of three transmission ratios for improving fuel efficiency under a high-speed cruising condition.

Further, the power train provides functions suitable for plug-in hybrid vehicles or fuel cell vehicles. That is, providing a plurality of shift stages in the EV modes will allow the motor to be driven with high efficiency since these vehicles have longer traveling distance in an electric vehicle mode.

Further, as in the EV1′ mode, since two motor generators provide a high-torque under-drive transmission ratio where they all operate as motors, it is possible to satisfy when a driver needs high level of acceleration.

Meanwhile, as described above, since the present invention can provide traveling modes of four EV modes, two HEV modes, and three ENG modes, using two planetary gear sets and maximum five clutch/brake members, as compared with other power trains in the related art, the present invention reduces the cost and the weight by reducing the number of parts, and has a technical advantage in terms of mounting characteristic in a vehicle, power performance, and fuel efficiency.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A power train of a hybrid vehicle comprising:
a first planetary gear set connected with an output element and a first motor generator;
a second planetary gear set aligned coaxially with the first planetary gear set and connected with the output element, an input element, and a second motor generator;
a first clutch configured to selectively fix a mode shift gear element of the first planetary gear set; and
a second clutch configured to selectively connect the mode shift gear element of the first planetary gear set with a gear element of the second planetary gear set that is not connected with the second motor generator and the output element.

2. The power train of a hybrid vehicle as defined in claim 1, further comprising:
a third clutch configured to selectively fix a gear element of the second planetary gear set that is connected with the second motor generator; and
a fourth clutch configured to connect the gear element of the second planetary gear set that is not connected with the second motor generator and the output element with a gear element of the first planetary gear set that is connected with the first motor generator.

3. The power train of a hybrid vehicle as defined in claim 2, further comprising:
a fifth clutch configured to selectively connect the input element with a gear element of the second planetary gear set.

4. The power train of a hybrid vehicle as defined in claim 1, wherein the output element is connected with a carrier of the first planetary gear set and a ring gear of the second planetary gear set.

5. The power train of a hybrid vehicle as defined in claim 1, wherein the mode shift gear element is a ring gear of the first planetary gear set.

6. The power train of a hybrid vehicle as defined in claim 1, wherein the first motor generator is connected to a sun gear of the first planetary gear set,
the output element is connected to a carrier of the first planetary gear set, and
the first clutch and the second clutch are connected to a ring gear of the first planetary gear set.

7. The power train of a hybrid vehicle as defined in claim 1, wherein the first motor generator is connected to a sun gear of the first planetary gear set,
the output element is connected to a ring gear of the first planetary gear set, and
the first clutch and the second clutch are connected to a carrier of the first planetary gear set.

8. The power train of a hybrid vehicle as defined in claim 1, wherein the second motor generator is connected to a sun gear of the second planetary gear set,
the output element is connected to a ring gear of the second planetary gear set, and
the input element and the second clutch are connected to a carrier of the second planetary gear set.

9. The power train of a hybrid vehicle as defined in claim 1, wherein the second motor generator is connected to a sun gear of the second planetary gear set,
the output element is connected to a carrier of the second planetary gear set, and
the input element and the second clutch are connected to a ring gear of the second planetary gear set.

10. A power train of a hybrid vehicle comprising:
a first planetary gear set that is connected with an output element and a first motor generator;
a second planetary gear set that is connected with an input element and a second motor generator;
a first clutch connected with a gear element of the first planetary gear set that is not connected with the output element;
a second clutch connected with a gear element of the second planetary gear set that is not connected with the second motor generator and the output element;
a third clutch connected with a gear element of the second planetary gear set that is not connected with the output element; and
a fourth clutch connected with the first planetary gear set and the second planetary gear set.

11. The power train of a hybrid vehicle as defined in claim 10, further comprising:
a fifth clutch configured to selectively connect the input element with a gear element of the second planetary gear set.

12. The power train of a hybrid vehicle as defined in claim 11, wherein a first carrier of the first planetary gear is directly connected to a second ring gear of the second planetary gear, and
the first carrier of the first planetary gear is connected to the output element.

13. The power train of a hybrid vehicle as defined in claim 12, wherein a first sun gear of the first planetary gear is connected to the first motor generator,
a first ring gear of the first planetary gear is connected through the first clutch in order to be selectively rotated, and
a second carrier of the second planetary gear is selectively connected to the first ring gear of the first planetary gear via the second clutch.

14. The power train of a hybrid vehicle as defined in claim 13, wherein the second carrier of the second planetary gear is connected to the first motor generator via the fourth clutch and an engine as an input element via the fifth clutch, and
a second sun gear of the second planetary gear is directly connected to the second motor generator and selectively fixed via the third clutch.
